(19) United States
(12) Patent Application Publication
(10) Pub. No.: US 2011/0042913 A1
(43) Pub. Date: Feb. 24, 2011

(54) SKATEBOARD

(75) Inventor: Sergio Landau, Laguna Niguel, CA (US)

Correspondence Address: Schwabe Williamson & Wyatt;PACWEST CENTER, SUITE 1900, 1211 SW FIFTH AVENUE, PORTLAND, OR, 97204, US

(73) Assignee: PARDAU, LLC, Laguna Niguel, CA (US)

(21) Appl. No.: 12/941,025

(22) Filed: Nov. 5, 2010

Related U.S. Application Data
(63) Continuation-in-part of application No. 12/272,698, filed on Nov. 17, 2008.
(60) Provisional application No. 61/078,423, filed on Nov. 17, 2008.

(51) Int. Cl. B60G 11/18; A63C 17/26

(52) U.S. Cl. 280/87.042; 267/285

(57) ABSTRACT

A skateboard is provided with a deck providing a support platform for the user, a front and rear wheel sets and trucks coupled to the deck. The support platform may include a central portion and raised front and rear portions. The front and rear portions may angle upwardly from the central portion, and then angle downwardly. The trucks may be coupled to the deck at the downwardly angled portions. The front and rear trucks may each include a pair of torsion springs alongside a kingpin. The hardness of the torsion springs may be varied to alter the performance of the skateboard depending on the characteristics of the user. A foot-operated brake may be mounted to the rear portion of the support platform. The deck may include a hinged portion located between the front and rear portions with a handle located in the hinged portion of the deck. The torsion springs may be provided with an identifier based upon their hardness. In certain examples that identifier may be a color coding system.

### CROSS-REFERENCE TO RELATED APPLICATIONS

The present application is a continuation-in-part of, and claims priority to, U.S. patent application Ser. No. 12/272,698, filed on Nov. 17, 2008, entitled “Skateboard,” which claims priority under 35 U.S.C. §119(e) to U.S. Provisional Patent Application Ser. No. 61/078,423, filed on Jul. 6, 2008. The complete disclosures of the above-identified patent applications are hereby incorporated by reference for all purposes.

### BACKGROUND

Skateboards are generally provided with a deck and two pairs of wheels, with front and rear trucks each coupling one pair of the wheels to the deck. The skateboard rolls as propelled by a rider and/or in a downhill direction, and the trucks steer the wheels in the direction that the rider tilts the deck. Typical skateboards are suited only to low speed operations because of the lack of stability from the small size of the wheels and the placement of the deck over the wheels. Some skateboards, such as longboards, are more suited to cruising operation, and may be more suitable for higher speeds and are used for transportation. However, even longboards usually lack a braking mechanism, which further detracts from high speed operation. Skateboards are also cumbersome to carry and to stow due to their size and shape. Furthermore, skateboards do not allow customization to adjust for the weight and/or desired riding speed of the user.

### SUMMARY

The disclosed skateboard includes a deck with an upper surface that is close in elevation to the axes of rotation of the wheels. For example, the upper surface may be slightly above, generally level with, or below the axes of rotation of the wheels, or may be at another elevation as suited to a desired application of the skateboard. The deck may have a uniform elevation, or may include portions at different elevations. For example, the deck may include a central portion at a low elevation and raised front and/or rear portions to facilitate mounting of trucks beneath the deck while maintaining a low elevation for the central portion of the deck.

The skateboard of the present disclosure includes trucks that preferably are mounted to the deck and each truck connects an axle to the deck so that the wheels mounted on the axle are steered by a tilting of the deck. For example, each truck may be mounted by a kingpin coupled to the deck at an angle offset from vertical, with a pair of torsion springs, or other cushions or shock absorbers alongside the kingpin biasing the wheels to a neutral steering position. The angled mount of the kingpin causes the wheels to diverge from the neutral position when the deck is tilted. A stop may be provided adjacent the trucks to limit the divergence of the wheels from the neutral position.

The angled mount may be provided by locating a hole for each kingpin in an angled portion of the deck, for example, in front and rear downwardly-angled portions. The kingpin hole may be aligned with other holes or cavities in the deck to facilitate a molded construction for the deck.

The hardness of the provided torsion springs may be varied to adjust to the weight of the user, the desired riding speed, user preference and/or other factors. The hardness of each torsion spring may be varied independently to achieve the desired skateboard performance. The trucks may be coupled to the deck by a readily removable coupler such that the user may exchange one or more of the torsion springs with a torsion spring of a different hardness.

The skateboard may also include a brake mounted to the board, preferably adjacent a rear portion of the deck. The brake may include a foot pedal coupled to a brake pad that contacts the ground in an operative condition. Such a brake may be mounted in an aperture through the deck and provided with a pivot axis and a mechanism to bias the brake to a non-operative condition.

The presently-disclosed deck may be provided with a two-segment construction with a central hinge coupling the two segments to allow for reconfiguring the skateboard between an unfolded position for riding and a folded position for carrying and stowing. A carrying handle may be provided on the skateboard, e.g., by being built into the hinge, to facilitate a user's transporting the skateboard when not in use. Preferably, the wheels are mounted alongside the deck, i.e., to the outside of right and left edges of the deck, and at different distances from the central hinge, so that the wheels do not interfere with folding the deck at the hinge.

One aspect of the skateboard simply provides a deck with a support platform for the user, a front truck mounted under a front portion of the support platform, a rear truck mounted under a rear portion of the support platform, and a plurality of torsion shocks or springs coupling at least one of the front truck and rear truck to the support platform, the torsion springs being independently selected from a group of torsion springs having different hardnesses. With respect to that aspect, the torsion springs may be provided with identifiers such as color coding according to their hardness, and the torsion springs may be interchangeable with one another.

The advantages of the present invention will be understood more readily after a consideration of the drawings and the Detailed Description.

### BRIEF DESCRIPTION OF THE DRAWINGS

FIG. 1 is a perspective view of a skateboard of the present disclosure, showing a deck that includes a hinge connecting front and rear segments, two trucks mounted beneath the deck, four wheels coupled to the trucks, and a foot-operable brake.

FIG. 2 is a side elevation of the skateboard of the present disclosure, with the near-side wheels removed to show the trucks beneath the deck and an aperture through a rear portion of the deck, through which extends an arm of the brake, and also showing a pivot axis of the hinge connecting the front and rear segments of the deck.

FIG. 3 is a side elevation similar to that of FIG. 2, with the brake illustrated in an operative condition with the pad contacting the ground.

FIG. 4 is an exploded view of the components of the deck, trucks, wheels, axles, brake, hinge, a pair of kingpins for mounting the trucks, two pairs of torsion springs for neutrally biasing the trucks, a pivot pin for the brake, and a carrying handle built into the hinge.

FIG. 4A is an exploded view similar to FIG. 4, illustrating a readily removable coupler configured to be hand fastened for coupling the trucks to the deck.

FIG. 5 is a partial perspective view of one end of a skateboard according to the present disclosure, showing the tilting motion of the deck producing the steering movement of the truck and wheels, and a pair of stops on the deck for limiting the steering motion of the truck.

FIG. 5A is a partial perspective view similar to FIG. 5, showing the readily removable coupler configured to be hand fastened.

FIG. 5B is a side perspective view of one end of a skateboard according to the present disclosure, showing how the readily removable coupler may be coupled to the truck.

FIG. 5C shows a perspective view of one end of the skateboard with the truck removed and a pair of torsion springs coupled to the deck.

FIG. 5D shows a side perspective view of one end of the skateboard showing how the truck may be coupled to the deck and the pair of torsion springs.

FIG. 5E is a perspective view of an end of the skateboard with the truck coupled to the torsion springs and deck before the readily removable coupler has been coupled to the truck.

FIG. 6 is a side view of a skateboard of the present disclosure in a folded condition, with the lower surfaces of the deck folded at the hinge towards one another and with the carrying handle deployed for hand transport, and the two pairs of wheels adjacent one another.

FIG. 7 is a perspective view from beneath the skateboard illustrating the alignment of cavities in the deck with a through hole for the kingpin.

FIG. 7A is a perspective view similar to FIG. 7, illustrating a readily removable coupler configured to be hand fastened to the truck.

FIG. 8 is a diagram illustrating combinations of torsion springs of various hardnesses.

### DETAILED DESCRIPTION

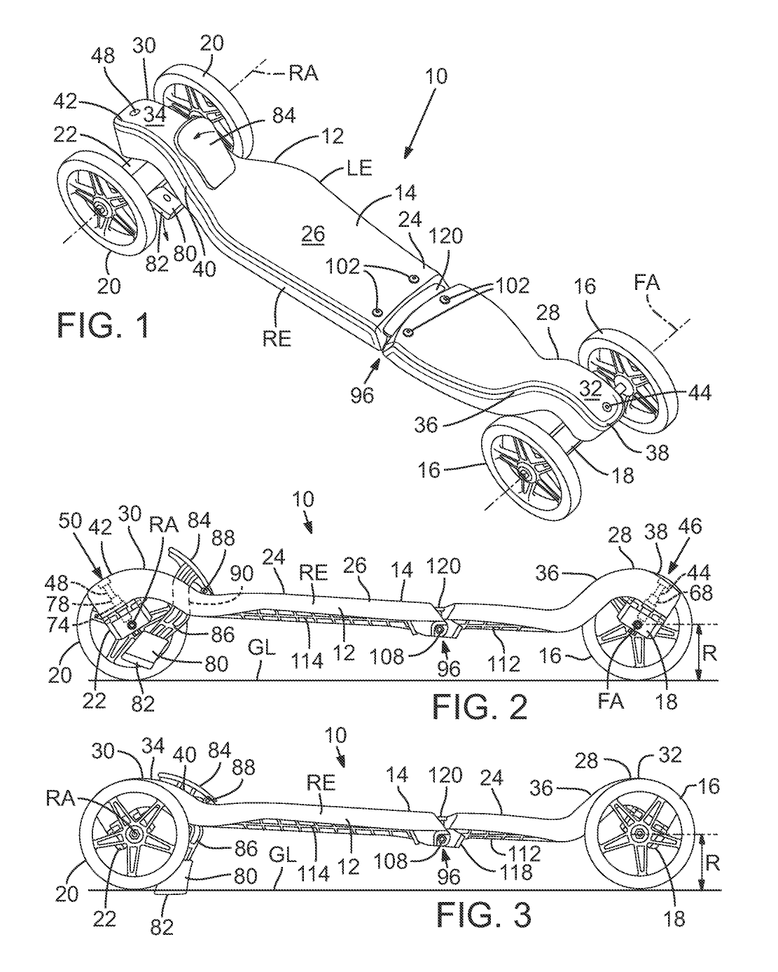

An exemplary skateboard according to the present disclosure is indicated generally at 10 in FIG. 1. A deck 12 of board 10 provides a support platform 14 for a rider or user (not shown). Deck 12 may be formed of any suitable material, e.g. molded plastic, with or without fiber or other reinforcement, or a multi-ply, laminate or other construction suited for the desired style of skateboard riding.

A pair of front wheels 16, which define a front axis of rotation FA, may be coupled to deck 12 by a front truck 18. A pair of rear wheels 20, which define a rear axis of rotation RA, may be coupled to deck 12 by a rear truck 22. Typically, wheels 16 and 20 are larger than the standard wheels of 2-inches to 4-inches in diameter used in skateboards and longboards. Although other combinations and sizes may be used, wheels 16 and 20 are typically at least about 5-inches in diameter or as large as 7-inches in diameter, or larger as suited to the particular skateboard design. Use of larger wheels typically allows a higher speed for the skateboard for a given force applied to the skateboard. Wheels 16 and 20 typically are about 1-inch wide, although other widths may be used, and thus a typical ratio of wheel diameter to width is at least about five and preferably about seven, although other sizes may be used. Wheels 16 and 20 are typically all the same size, although different combinations may be used.

The front and rear trucks may be formed of molded plastic, e.g., the same molded plastic as the deck, or formed of any other material suited to the skateboard's requirements. The wheels may be formed of any suitable material, such as polyurethane tires mounted to a plastic rim, and typically are provided with a bearing mounted in a hub.

The user typically stands on a central portion 24 of support platform 14, on an upper surface 26 of the support platform. Central portion 24 is between a front portion 28 and a rear portion 30 of support platform 14. Front portion 28 includes an upper surface 32 and rear portion 30 includes an upper surface 34. Preferably, upper surface 32 of front portion 28 and upper surface 34 of rear portion 30 are raised above upper surface 26 of central portion 24 of support platform 14. The upper surfaces of the front and rear portions may be raised, for example at their associated axes of rotation, by about 2-inches to 4-inches. Alternatively, the front and rear portions may be raised, kept level, or lowered in different combinations and to any height as suited for the desired skateboarding purpose. Upper surfaces 32, 34 of front and rear portions 28, 30 may provide a surface for the rider's feet, although in typical operation the feet would not be placed there.

Preferably, front portion 28 extends over front axis of rotation FA and rear portion 30 extends over rear axis of rotation RA. As can best be seen in FIGS. 2 and 3, raising the front and rear portions of the deck above the central portion allows the central portion to be substantially lower in elevation above a ground level GL as would otherwise be the case. Typically, upper surface 26 of central portion 24 is substantially level with at least one of the front and rear axes of rotation, and preferably upper surface 26 of central portion 24 is less than one wheel radius R above the front axis FA and rear axis RA of rotation. Alternatively, central portion 24 may be placed at any elevation relative to the front and rear axes of rotation. Upper surface 26 of central portion 24 may remain level from the front portion to the rear portion, or may be provided with a slope, such as the downward slope shown in FIGS. 2 and 3. A downward slope for the central platform tends to provide the rider with a more level platform while the rider is endeavoring to travel uphill with one foot on the deck and the other foot used to push along the ground. Also, on flat ground, the downward slope facilitates the rider's propelling the board forward because the slope allows the rider to lean forward which enhances balance and comfort during forward motion.

As may also be seen in FIGS. 1-3, front portion 28 may be designed with a curved shape including a first curvature 36 that, in a forward direction, angles upwardly from central portion 24, and a second curvature 38 that, angles downwardly. Similarly, rear portion 30 may be designed with a curved shape including a first curvature 40 that, in a rearward direction, angles upwardly from central portion 24, and a second curvature 42 that angles downwardly. It will be noted that for the embodiment of the skateboard in FIGS. 1-3, the first curvatures on the front and rear portions are placed closer to the central portion of the board than are the trucks. Preferably, second front curvature 38 and second rear curvature 42 angle downwardly at substantially equivalent, complementary angles. Alternatively, the front and rear portions may be provided with any shape as suited to a particular application.

Front truck 18 may be coupled to deck 12 adjacent front portion 28, for example, at second front curvature 38. Rear truck 22 may be coupled to deck 12 adjacent rear portion 30, for example, at second rear curvature 42. Coupling the trucks at these complementarily-angled locations provides for complementary steering of the wheels in response to the rider's tilting the deck.

For example, as best seen in FIGS. 2, 4, and 5, front truck 18 may be attached by a kingpin 44 to deck 12 at second curvature 38 of front portion 28. Kingpin 44 may be installed in a through hole 46 through the deck. Through hole 46 may be normal to upper surface 32 at second curvature 38, in which case kingpin 44 will be offset from vertical to the same degree as second curvature 38 is angled with respect to horizontal. Such angling of kingpin 44 results in a side-to-side tilting of deck 12 being translated into a redirection of wheels 16 as will be explained more fully below.

Similarly, a rear kingpin 48 may be attached at second curvature 42 of rear portion 30 through a hole 50, typically with geometry complementary to that for the front truck. For example, both the second front curvature 38 and second rear curvature 42 may angle downwardly at about 30-degrees, providing the kingpins with an offset from vertical of about 30-degrees. Alternatively, the trucks and kingpins may be configured with different geometries as suited to a desired steering setup.

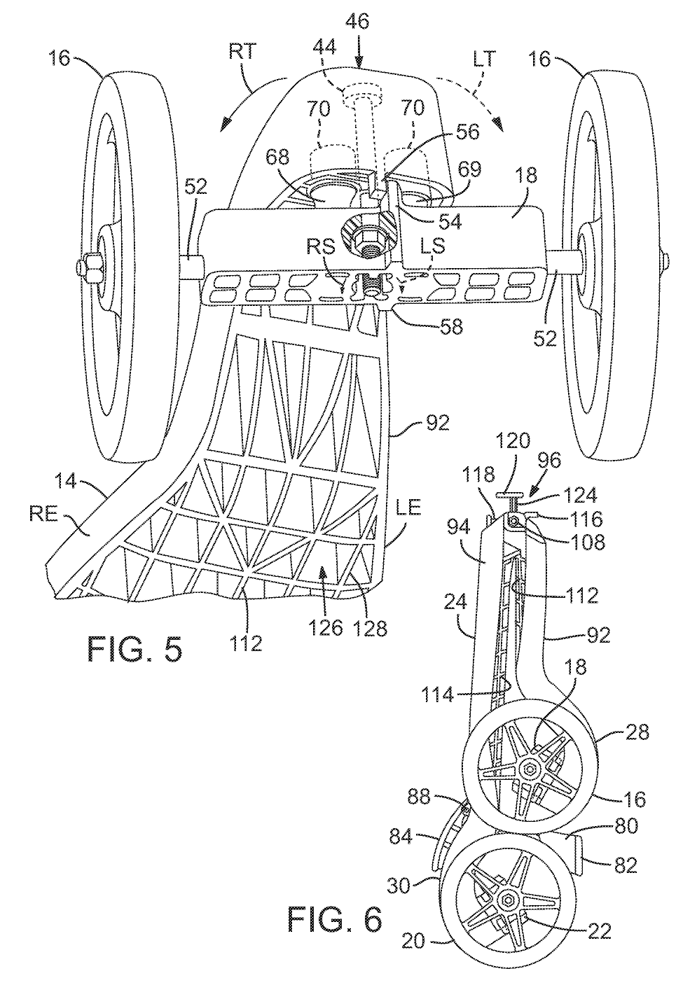

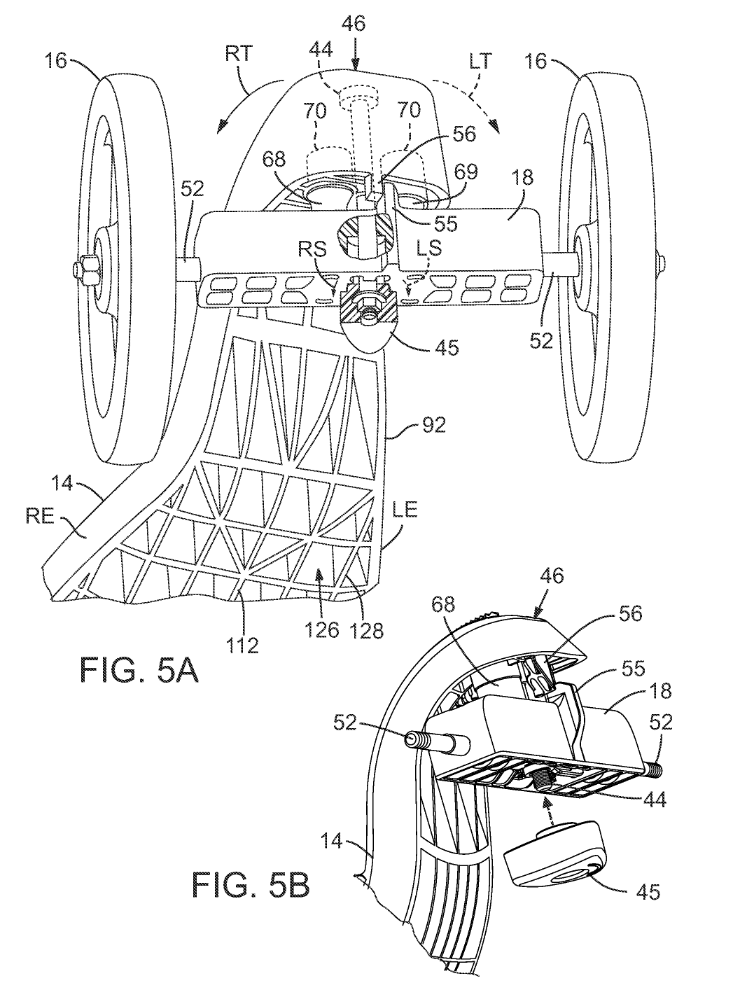

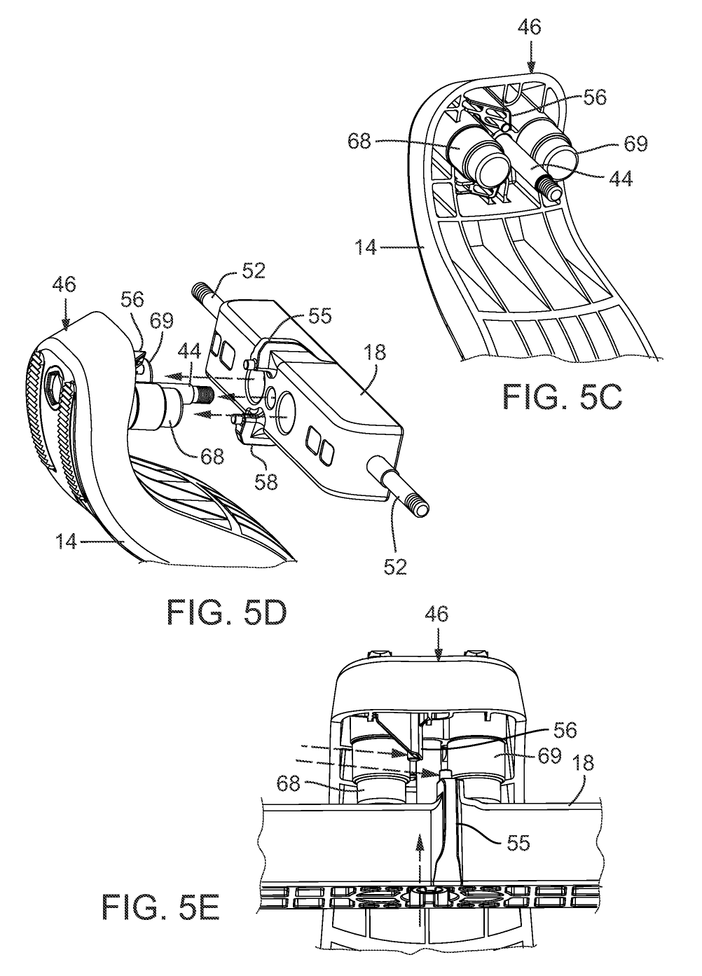

As best seen in FIG. 5, which illustrates a right hand turn with solid arrows and a left hand turn with dashed arrows, a downward tilting RT of a right edge RE of deck 12 causes a right hand steering RS of front truck 18. Similarly, a downward tilting LT of a left edge LE of deck 12 would cause a left hand steering LS of front truck 18. Typically, rear truck 22 is provided with a complementary mounting geometry that steers the rear wheels in the opposite direction of the front wheels, which tends to produce a circular path for the skateboard. Alternatively, other modes of steering may be provided, such as identically configured truck mounts for crab steering.

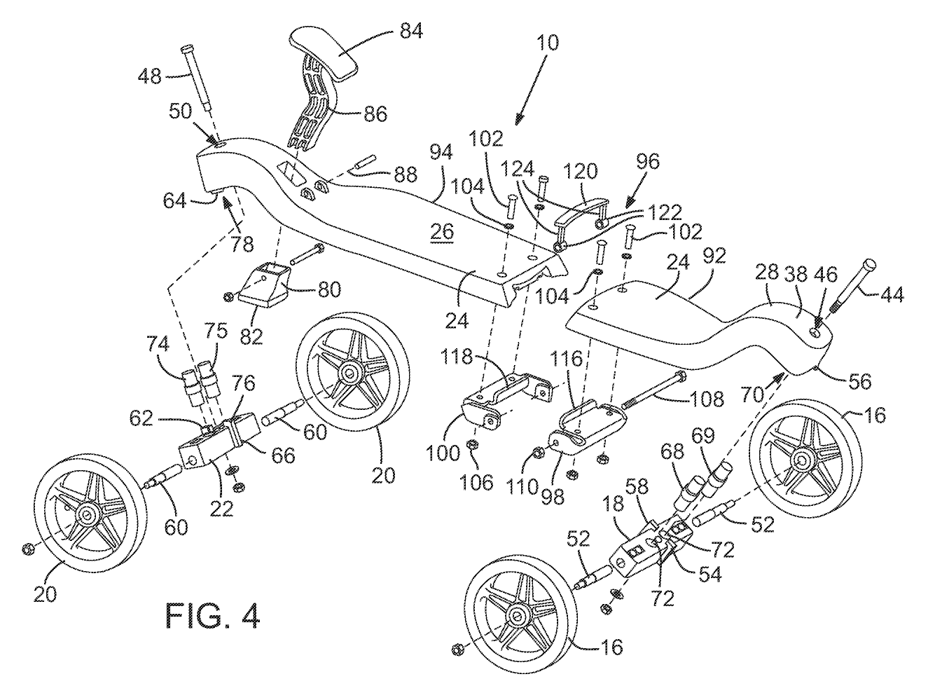

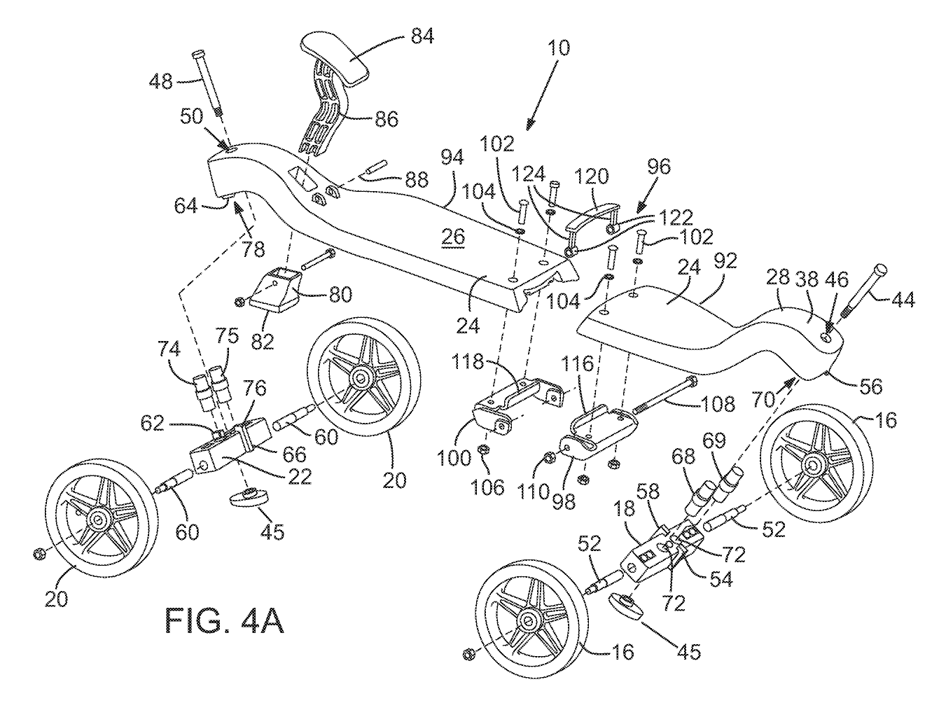

Front truck 18 may be provided with an axle, such as two-piece axle 52 and a stop 54 located adjacent the axle, for example on the front of the truck at an offset from the center of the truck, as shown in FIG. 5. Stop 54 may cooperate with a stop 56 at the front end of deck 12, e.g., at the center of the deck as shown in FIG. 5. The stops 54, 56 may cooperate to limit a divergence of the front axle from alignment with the deck, as illustrated for a right hand turn in FIG. 5. A second set of stops, including stop 58 on truck 18 may be provided in another location on truck 18 to limit, in cooperation with a stop (not shown) on deck 12, a divergence of the front axle from alignment with the deck for a left hand turn. Similarly, rear truck 22 may be provided with an axle, such as two-piece axle 60, and one or more sets of stops 62, 64, 66 for a similar limit on steering divergence of the rear truck and axle (FIG. 4).

Front truck 18 may be provided with a pair of torsion cylinders, such as springs 68 and 69, coupled to the support platform. For example, truck 18 may include a pair of cavities or pockets 70, each on one side of kingpin 44, into which one end of each torsion spring 68 or 69 is inserted. An opposing pair of pockets 72 may be provided in deck 12 adjacent front portion 28 to receive the other end of each torsion spring.

Rear truck 22 may be provided with a similar pair of torsion springs 74 and 75 and pockets 76 on the rear truck coordinated with pockets 78 in deck 12 adjacent rear portion 30. Preferably, each pair of springs 68 and 69, and 74 and 75 are arrayed substantially parallel to, and on opposite sides of the respective kingpin. Generally speaking, the torsion springs flexibly couple each axle to the deck. Alternatively, other tilt and steering control mechanisms may be provided in either or both of the front and rear portions of the deck.

Torsion springs 68, 69, 74 and 75 may be of any desirable hardness. For example, torsion springs 68, 69, 74 and 75 may have a durometer of about 50 Shore A (50 A) to about 110 A, or more particularly of about 65 A to about 100 A, such as about 75 A to about 90 A. In some embodiments, torsion springs 68, 69, 74 and 75 may all have the same hardness. In other embodiments, one or more of torsion springs 68, 69, 74 and 75 may be of a different hardness than one or more of the remaining torsion springs. The torsion springs may be substantially composed of any suitable resilient or compressible material, such as polyurethane.

In various embodiments, the torsion springs may be interchangeable such that any of the one or more torsion springs in the skateboard can be removed and replaced with a different torsion spring that may be of a different hardness. The hardness of each torsion spring may be selected based on the skill of the user, the weight of the user, the desired riding speed, the preference of the user, and/or other factors. In general, torsion springs of a higher hardness may be better suited for a more skilled (e.g. experienced) user, a heavier user and/or for riding the skateboard faster, while torsion springs of a lower hardness may be better suited for a less skilled (e.g. beginner) user, a lighter user and/or for riding the skateboard slower. Additionally, the softer suspension provided by torsion springs of lower hardness may make the skateboard easier to turn, which may be preferable for a beginning user. In contrast, more advanced users may prefer the additional speed and precise control that may be provided by a harder suspension with torsion springs of higher hardness.

In some embodiments, more than four interchangeable torsion springs may be provided to the user, with at least one torsion spring being of a different hardness than at least one other torsion spring. For example, torsion springs may be provided having at least two different hardnesses, such as about two to eight different hardnesses. In these embodiments, each of the four torsion springs on the skateboard may be independently selected from the group of torsion springs provided, allowing the user to adjust the hardness of the torsion springs according to his or her preference. The skateboard may be configured such that the user may exchange each torsion spring in the skateboard with a torsion spring of a different hardness.

The sum of the hardnesses of the front torsion springs may equal a total front truck hardness, while the sum of the hardnesses of the rear torsion springs may equal a total rear truck hardness. In some embodiments, the skateboard may be configured such that the performance of the skateboard will be substantially the same for a given total front truck hardness and total rear truck hardness, regardless of the individual hardnesses of each torsion spring within the front truck pair or rear truck pair, or the relative position of each torsion spring within the pair, i.e. on the left or the right. For example, the performance of the skateboard may be substantially the same whether the two torsion springs making up the front truck pair both have a hardness of 80 A, or if one torsion spring with a hardness of 75 A is paired with a torsion spring with a hardness of 85 A. Similarly, the performance of the skateboard may be substantially the same for a skateboard with a 75 A torsion spring in the left front position and an 85A torsion spring in the right front position, as for a skateboard with an 85 A torsion spring in the left front position and a 75 A torsion spring in the right front position.

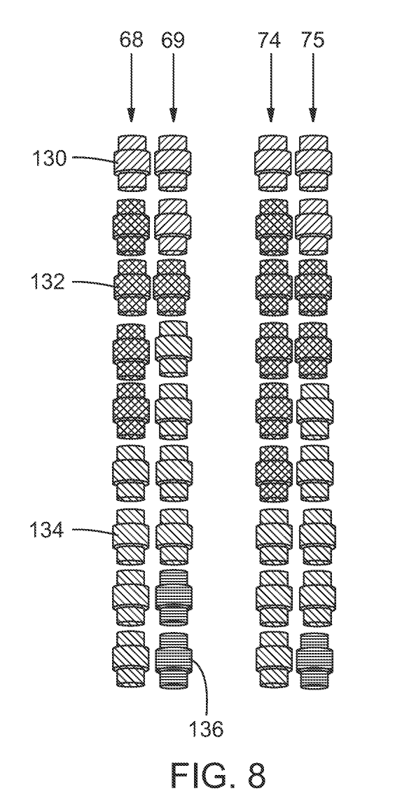

FIG. 8 illustrates how different combinations of torsion springs of various hardnesses may be utilized to adjust the performance of the skateboard according to the preference of the user. In the illustrated embodiment, torsion springs 68, 69, 74 and 75 may be selected from a group of torsion springs that are color-coded according to their hardness. For example, 75 A torsion springs 130 may be yellow, 80 A torsion springs 132 may be blue, 85 A torsion springs 134 may be red, and 90 A torsion springs 136 may be black. Alternatively, the torsion springs may be provided with any other identifier, such as numbers, letters, symbols, shapes or sizes, that permits them to be identified according to their hardness. In any event, the torsion springs may be interchangeable such that any of the one or more torsion springs in the skateboard can be removed and replaced with a different torsion spring that may be of a different hardness. In general, the total hardness of the torsion springs on the skateboard may be increased for faster riding and/or a heavier user, as shown in FIG. 8, although other factors may be considered. Torsion springs of differing hardnesses may be paired within the front truck and/or rear truck to create the desired total front truck hardness and total rear truck hardness, respectively. Similarly, the total front truck hardness may or may not be equal to the total rear truck hardness.

As discussed above, the front truck may be attached by a front kingpin to the front portion of the skateboard deck and the rear truck may be attached by a rear kingpin to the rear portion of the skateboard deck. In various embodiments, the front and rear trucks may be coupled to their respective kingpins such that the front and rear trucks can be decoupled from the kingpin by the user in order to exchange one or more of the torsion springs for a torsion spring of a different hardness. For example, a lower portion of the front and rear kingpins may be threaded, and the front and rear trucks may be coupled to their respective kingpins by a nut and washer or other suitable, readily removable coupler. In some embodiments, the readily removable coupler may be configured such that it may be hand fastened, i.e., fastened without the need for a tool, e.g., a wrench. For example, the readily removable coupler may include a threaded portion with an inner diameter such that it can be coupled to the kingpin and an outer diameter that is significantly larger than the inner diameter to facilitate coupling the truck to the kingpin by hand fastening the readily removable coupler to the kingpin. For instance, in some embodiments where the readily removable coupler is configured to be hand fastened, the outer diameter of the readily removable coupler may be about one to about four inches, although other outer diameters may be used. FIGS. 4A, 5A-B, and 7A show examples of a readily removable coupler 45 that is configured to be hand fastened. By configuring the readily removable couplers such that they may be hand fastened to their respective kingpins allows the user the ability to easily exchange one or more of the torsion springs in the skateboard for a different torsion spring. This process is illustrated in FIGS. 5B-E for the front side of the skateboard. Torsion springs 68 and 69, which may be selected from a group of torsion springs having different hardnesses, may be coupled to deck 12 as shown in FIG. 5C. Front truck 18 may then be coupled to torsion springs 68 and 69 as illustrated in FIGS. 5D-E. Front truck 18 may be tightened in place by coupling readily removable coupler 45 to kingpin 44 as shown in FIG. 5B. Readily removable coupler may couple to kingpin 44 through a threaded mechanism or other suitable mechanism. Once skateboard 10 is assembled, torsion springs 68 and/or 69 may be exchanged for torsion springs of a different hardness by reversing the procedure outlined above, removing one or more of torsion springs 68 and 69 and substituting one or more torsion springs of a different hardness.

Referring to FIGS. 1-4, skateboard 10 may include a brake 80 mounted to support platform 14, preferably adjacent rear portion 30. Brake 80 may be foot-operated, as illustrated in FIG. 2 (in the non-operative condition) and FIG. 3 (in the operative condition). Brake 80 may include a ground-contacting pad 82, a pedal 84, an arm 86 interconnecting the arm and the pad, and a pivotal mount 88 to provide for the movement between the operative and non-operative conditions. Preferably, an aperture 90 is provided through the deck and arm 86 extends through aperture 90. Typically, the brake will also include a biasing mechanism, such as a spring (not shown) to bias the brake to the non-operative condition. Alternatively, brake 80 may be provided in a different location on support platform 14 or be differently configured for a desired riding application.

As best seen in FIGS. 4 and 6, deck 12 may be formed of more than one segment, such as front segment 92 and rear segment 94 that may be joined at a hinged portion 96. For example, front segment 92 may include front portion 28 and rear segment 94 may include rear portion 30, with central portion 24 divided between the front and rear segments.

Hinged portion 96 may include a front hinge half 98 and a rear hinge half 100, each coupled to a respective segment, e.g., by bolts 102, washers 104, and nuts 106. Hinge halves 98 and 100 may be coupled by a pin 108 fastened by a nut 110 or other hardware in a manner allowing deck 12 to fold at hinged portion 96 as shown in FIG. 6. As noted above, deck 12 defines right side edge RE and left side edge LE, and wheels 16 and 20 may be mounted outside of the side edges.

Preferably, hinged portion 96 is offset from the center of central portion 24 so that, when the deck is folded at the hinged portion, wheels 16 and 20 do not interfere with the folding, but instead are separated, or just touching, as shown in FIG. 6. In the folded position, a front underside 112 of deck 12 located in front of the hinged portion and a rear underside 114 of deck 12 located to the rear of the hinged portion may be substantially parallel to, and facing one another. Preferably, skateboard 10 is held in the unfolded position by gravity and by a pair of opposed flanges 116, 118, one on each of hinge halves 98 and 100. A latch or other means may be used to releasably fix the skateboard in either or both of the folded and unfolded positions. Preferably, only gravity holds the skateboard in the folded position.

A handle 120 for carrying the skateboard, may be provided at any convenient location on the skateboard. For example, handle 120 may be located in hinged portion 96 and may be coupled at a pair of hubs 122 on a pair of handle arms 124 to hinge pin 108. Preferably, the handle becomes accessible for carrying when deck 12 is folded at hinged portion 96, and, in a riding configuration, such as the unfolded position, handle 120 is substantially below upper surface 26 of support platform 14.

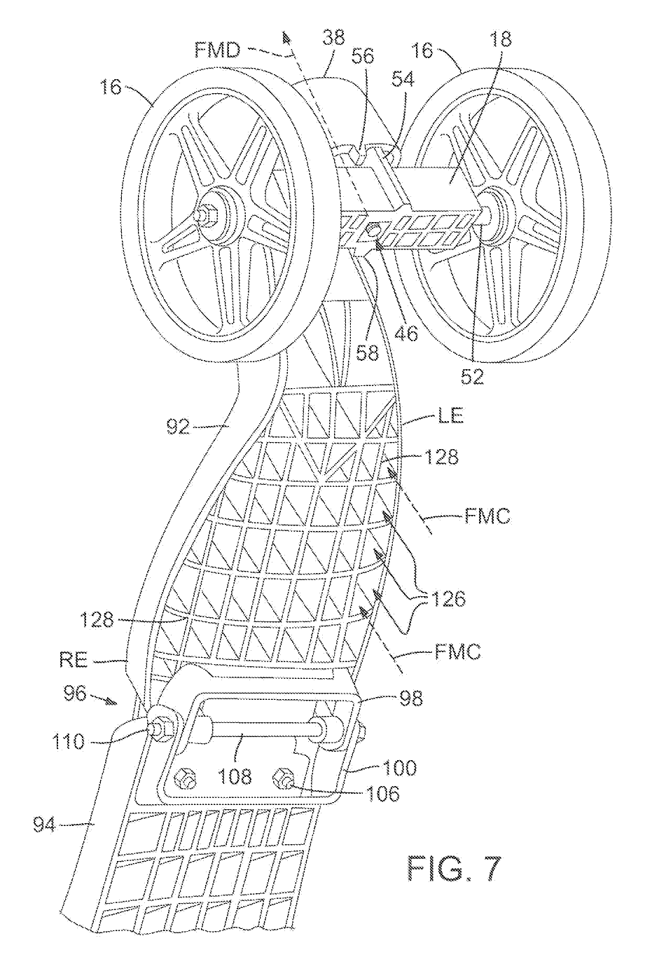

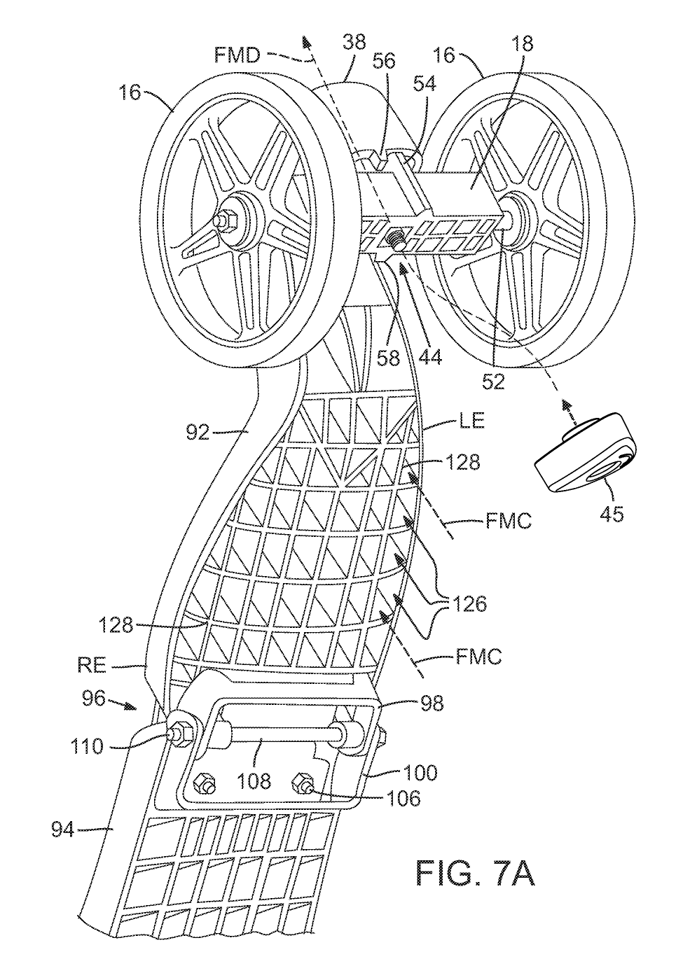

As best seen in FIG. 7, through hole 46 in front segment 92, that is configured to receive kingpin 44, may be aligned in a direction FMD that corresponds to the direction FMC of cavities 126 between ribs 128. Such alignment of the kingpin hole and the cavities facilitate molding of front segment 92 because it allows the hole and cavities to be formed between two halves of a mold and removed from the mold without a requirement for slides or other movable in-mold hardware. Rear segment 94 may be provided with a similar alignment for the kingpin hole and cavities.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically indicated.

Inventions embodied in various combinations and subcombinations of features, functions, elements, and/or properties may be claimed through presentation of new claims in this or a related application. Such new claims, whether they are directed to a different invention or directed to the same invention, whether different, broader, narrower or equal in scope to the original claims, are also regarded as included within the subject matter of the inventions of the present disclosure. The described examples are illustrative and directed to specific examples of apparatus and/or methods rather than a specific invention, and no single feature or element, or combination thereof, is essential to all possible combinations. Thus, any one of various inventions that may be claimed based on the disclosed example or examples does not necessarily encompass all or any particular features, characteristics or combinations, unless subsequently specifically claimed.

The invention claimed is:

1. A skateboard for a user to ride, the skateboard comprising:
a deck providing a support platform for the user;
a front truck mounted under a front portion of the support platform;
a rear truck mounted under a rear portion of the support platform; and
a plurality of torsion springs coupling at least one of the front truck and rear truck to the support platform, the torsion springs being independently selected from a group of torsion springs having different hardnesses; and
wherein the torsion springs are provided with an identifier according to their hardness, and are interchangeable with one another.

2. The skateboard of claim 1, wherein the torsion springs have a hardness that is different from the hardness of one or more of the remaining torsion springs.

3. The skateboard of claim 1, wherein at least one of the front truck and rear truck are coupled to the support platform with a readily removable coupler, such that the user may exchange one or more of the torsion springs for one or more torsion springs of a different hardness.

4. The skateboard of claim 3, wherein the readily removable coupler may be hand fastened.

5. The skateboard of claim 1, wherein
two of the torsion springs form a front torsion spring pair coupled to the front truck; and
two of the torsion springs form a rear torsion spring pair coupled to the rear truck;
wherein at least one of the front torsion spring pair and rear torsion spring pair includes torsion springs of differing hardnesses.

6. The skateboard of claim 1, wherein
two of the torsion springs form a front torsion spring pair coupled to the front truck; and
two of the torsion springs form a rear torsion spring pair coupled to the rear truck;
wherein at least one of the front torsion spring pair and rear torsion spring pair includes torsion springs of the same hardness.

7. The skateboard of claim 1, wherein the group of torsion springs includes torsion springs having a hardness within the range of about 50 Shore A to about 110 Shore A.

8. The skateboard of claim 1, wherein the group of torsion springs includes torsion springs having a hardness within the range of about 75 Shore A to about 90 Shore A.

9. The skateboard of claim 1, wherein the torsion springs are composed substantially of a compressible material.

10. The skateboard of claim 9, wherein the compressible material is polyurethane.

11. The skateboard of claim 1, wherein the identifier is a color coding.

12. The skateboard of claim 1, further comprising:
a front wheel set coupled to the deck and defining a front axis of rotation; and
a rear wheel set coupled to the deck and defining a rear axis of rotation;
wherein the support platform includes a central portion defining an upper surface, a front portion defining an upper surface, and a rear portion defining an upper surface, the front portion extending over the front axis of rotation and the rear portion extending over the rear axis of rotation, and further wherein the upper surface of at least one of the front and rear portions at the associated axis of rotation is raised above the upper surface of the central portion.

13. The skateboard of claim 7 wherein the upper surface of the central portion is substantially level with at least one of the front and rear axes of rotation.

14. The skateboard of claim 7 wherein the support platform slopes downwardly from adjacent the rear wheel set toward the front wheel set.

15. The skateboard of claim 7 wherein at least one of the front portion and the rear portion of the support platform include an upper surface that is at least about 2-inches above the upper surface of the support platform.

16. The skateboard of claim 6 wherein the front and rear wheels sets include wheels having a diameter of at least about five inches.

17. The skateboard of claim 1 wherein at least one of the front and rear portions, in a direction away from the central portion, angles upwardly from the central portion, and then, in the same direction away from the central portion, angles downwardly.

18. The skateboard of claim 12 wherein at least one of the front and rear trucks are coupled to the deck at the at least one of the front and rear portions at a location where the portion angled downwardly.

19. The skateboard of claim 5 wherein one of the front torsion springs is a different hardness from the other front torsion spring such that the cushioning provided by the front torsion springs is the average between the two front torsion springs.

20. The skateboard of claim 5 wherein one of the back torsion springs is a different hardness from the other back torsion spring such that the cushioning provided by the back torsion springs is the average between the two back torsion springs.

21. A skateboard for a user to ride, the skateboard comprising:
a deck providing a support platform for the user;
a front truck coupling the deck to a front wheel set, the front truck including a front kingpin coupling the deck to a front wheel axle and a front pair of torsion springs arrayed substantially parallel to, and on opposite sides of the front kingpin, the torsion springs flexibly coupling the front axle to the deck; and
a rear truck coupling the deck to a rear wheel set, the rear truck including a rear kingpin coupling the deck to a rear wheel axle and a rear pair of torsion springs arrayed substantially parallel to, and on opposite sides of the rear kingpin, the torsion springs flexibly coupling the rear axle to the deck;
wherein each of the torsion springs making up the front pair of torsion springs and rear pair of torsion springs are independently selected from a group of torsion springs having different hardnesses, and the springs include identifiers according to their hardness, and are interchangeable with one another.

22. The skateboard of claim 21, wherein at least one of the front pair of torsion springs and rear pair of torsion springs includes torsion springs of differing hardnesses.

23. The skateboard of claim 21, wherein at least one of the front pair of torsion springs and rear pair of torsion springs includes torsion springs of the same hardness.

24. The skateboard of claim 21, wherein the front kingpin is coupled to the front wheel axle with a readily removable coupler and the rear kingpin is coupled to the rear wheel axle with a readily removable coupler, such that the user may remove one or more of the torsion springs and replace it with one or more torsion springs of a different hardness.

25. The skateboard of claim 21, wherein the readily removable couplers may be hand fastened.

26. The skateboard of claim 21 wherein the group of torsion springs includes torsion springs having a hardness within the range of about 50 Shore A to about 110 Shore A.

27. The skateboard of claim 21 wherein the group of torsion springs includes torsion springs having a hardness within the range of about 75 Shore A to about 90 Shore A.

28. The skateboard of claim 21 wherein the torsion springs are composed substantially of a resilient material.

29. The skateboard of claim 21 wherein the torsion springs are composed of polyurethane.

30. The skateboard of claim 21 wherein the at least one of the front and rear trucks includes a pair of pockets, each pocket receiving an end of one of the torsion springs.

31. The skateboard of claim 21 wherein the support platform further includes a front portion rising above the central portion for coupling to the front truck and a rear portion rising above the central portion for coupling to the rear truck.

32. The skateboard of claim 21 wherein at least one of the front and rear kingpins are tilted from vertical by about thirty degrees.

33. A plurality of torsion springs color coded according to their hardness, the torsion springs being adapted for use in a skateboard, the skateboard having:
a deck providing a support platform for the user;
a front truck coupling the deck to a front wheel set; and
a rear truck coupling the deck to a rear wheel set;
wherein at least one of the front truck and rear truck includes one or more torsion springs flexibly coupling the truck to the deck.

34. The skateboard of claim 33, wherein the torsion springs have a hardness within the range of about 50 Shore A to about 110 Shore A.

35. The skateboard of claim 34, wherein the torsion springs have a hardness within the range of about 75 Shore A to about 90 Shore A.

36. The skateboard of claim 33, wherein the torsion springs are composed substantially of a resilient material.

37. The skateboard of claim 35, wherein the resilient material is polyurethane.
